(19) United States
(12) Patent Application Publication
(10) Pub. No.: US 2012/0290781 A1
(43) Pub. Date: Nov. 15, 2012

(54) NONVOLATILE MEMORY DEVICE WITH INCREASED ENDURANCE AND METHOD OF OPERATING THE SAME

(76) Inventors: Dong-young Seo, Gyeonggi-do (KR); Dong-kun Shin, Seoul (KR)

(21) Appl. No.: 13/445,214

(22) Filed: Apr. 12, 2012

(30) Foreign Application Priority Data
May 12, 2011 (KR) 10-2011-0044675

(51) Int. Cl. G06F 12/00

(52) U.S. Cl. 711/104; 711/154; 711/E12.001

(57) ABSTRACT

A non-volatile memory device including a memory unit configured to store user data and metadata and a memory controller unit. The memory controller unit is configured to access the memory unit in response to a request from an external host, create metadata which is to be recorded in the memory unit, and convert a format of the metadata based on a result of counting the number of times the memory unit is accessed.

### CROSS-REFERENCE TO RELATED APPLICATIONS

This application claims the benefit of Korean Patent Application No. 10-2011-0044675, filed on May 12, 2011, in the Korean Intellectual Property Office, the disclosure of which is incorporated herein in its entirety by reference.

### BACKGROUND

One or more example embodiments relate to a non-volatile memory device and/or a method of operating the same.

Non-volatile memory is a type of semiconductor memory device memory that can retain stored information when not powered. Since non-volatile memory devices provide good data retention, they are often used as storage media in memory systems. Non-volatile memory devices have gained much attention as a highly-integrated large-capacity device for replacing existing hard disks or floppy disks. Current non-volatile memory devices are used as storage media of mobile phones, digital cameras, MP3 players, and solid state drives (SSDs).

Systems such as personal computers or mobile terminals require a file system in order to use a memory device. A file system denotes a structure or software that is used to store data in a memory device included in systems, and an example of the file system is a file allocation table (FAT) file system. In a file system such as a FAT file system, user data such as texts, images, and sounds, and metadata for using a memory device may be stored in a non-volatile memory device. Metadata denotes data other than user data and may include a variety of software constituting a file system, various translation layers associated with an operation of a memory device, or a variety of file information such as the file names, sizes, creation time, and the like of files stored in the memory device.

An operating system or an application may frequently update metadata during operation thereof. Each piece of metadata is located in a certain space of the memory device, and thus updates to certain metadata may result in a specific region of a non-volatile memory device being updated more frequently than other regions. However, non-volatile memory devices such as flash memory devices or phase change RAMs (PRAMs) have a limit in update endurance, and thus, when a specific region is frequently updated, the lifespan of the non-volatile memory devices may be decreased. To address this problem, there has been conventionally proposed a block-by-block wear leveling technique. However, the technique of block-by-block wear leveling may result in an inefficient data copying operation since the operation is performed on a block-by-block basis during the update of small-size metadata.

### SUMMARY

The inventive concepts provide a non-volatile memory device with increased endurance by reducing the number of times a specific region is updated, and a method of operating the non-volatile memory device.

According to an embodiment, there is provided a non-volatile memory device including: a memory unit configured to store user data and metadata; and a memory controller unit configured to access the memory unit in response to a request from an external host, create metadata which is to be recorded in the memory unit, and convert a format of the metadata based on a result of counting a number of times the memory unit is accessed.

The memory controller unit may include a metadata provision unit configured to generate and convert the metadata and provide the metadata to the memory unit; a metadata detection unit configured to receive the metadata from the memory unit and extract at least one piece of information included in the metadata; and a counter configured to count the number of times the memory unit is accessed.

The metadata may include a plurality of segments that store a plurality of pieces of information, and the metadata provision unit may be configured to convert the format of the metadata by varying storage locations of the plurality of segments on the memory unit.

The metadata may include file information associated with the user data, and the memory controller unit may be configured to convert a format of the file information based on a result of counting the number of times the user data stored in the memory unit is accessed.

The file information may be a directory entry of a file allocation table (FAT) file system.

The memory controller unit may be configured to count a number of times a write operation is performed on the user data stored in the memory unit and convert the format of the file information based on a result of the counting.

The memory unit may include a first memory configured to store the user data and a second memory configured to store the metadata.

The second memory may be a Phase-change Random Access Memory (PRAM).

According to another embodiment, there is provided a method of operating a non-volatile memory device, the method including: storing user data and metadata in a memory, the memory including a plurality of pieces of information; performing an access operation on the memory to read at least one of the user data and the metadata; converting a format of the metadata by varying storage locations of the plurality of pieces of information; and updating the format-converted metadata in the memory.

In another embodiment, there is provided a semiconductor device including: a memory unit configured to store user data and metadata; and a memory controller configured to, generate the metadata, generate a memory count value representing a number of times a memory unit is accessed, convert the metadata based on the generated memory count value, and record the user data and metadata in the memory unit.

The metadata may comprise a plurality of information segments; and the memory controller may be configured to convert the metadata by shifting the information segments to different locations within the memory unit.

### BRIEF DESCRIPTION OF THE DRAWINGS

Exemplary embodiments of the inventive concepts will be more clearly understood from the following detailed description taken in conjunction with the accompanying drawings in which:

FIGS. 1A and 1B are block diagrams of a memory system including a non-volatile memory device, according to one or more example embodiments of the inventive concepts and;

FIG. 2 illustrates an example format of metadata that is applied to the inventive concepts;

FIG. 3 is a block diagram of an example embodiment of the non-volatile memory device of FIGS. 1A and 1B;

FIG. 4 illustrates an example of converting a format of a directory entry of a file allocation table (FAT) file system as an example of metadata;

FIGS. 5A and 5B illustrate another example of converting a format of metadata;

FIG. 6 is a flowchart of a method of operating a non-volatile memory device, according to an example embodiment of the inventive concepts;

FIG. 7 is a flowchart of a method of operating a semiconductor memory device, according to another example embodiment of the inventive concepts; and

FIG. 8 is a block diagram of an example of a memory system including a non-volatile memory device, according to an example embodiment of the inventive concepts.

### DETAILED DESCRIPTION OF THE EMBODIMENTS

Expressions such as “at least one of,” when preceding a list of elements, modify the entire list of elements and do not modify the individual elements of the list.

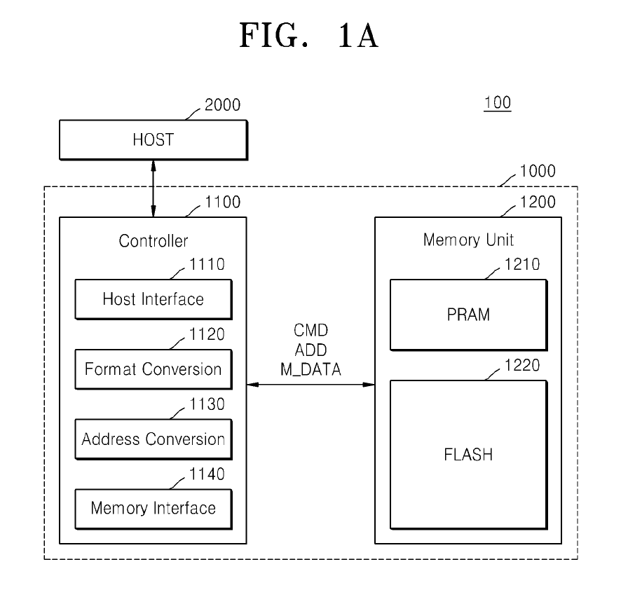

FIGS. 1A and 1B are block diagrams of a memory system 100 including a non-volatile memory device 1000, according to one or more example embodiments of the inventive concepts. As shown in FIG. 1A, the memory system 100 may include the non-volatile memory device 1000 and a host 2000. The non-volatile memory device 1000 may include a memory controller unit 1100 for controlling a memory operation such as writing, reading, and the like of data, and a memory unit 1200 including at least one non-volatile memory. The memory unit 1200 may include one type of non-volatile memory or at least two types of non-volatile memories. FIG. 1A illustrates an example in which the memory unit 1200 includes a phase change RAM (PRAM) 1210 and a flash memory 1220 as different types of non-volatile memory and FIG. 1B illustrates an example in which the memory unit 1200 includes a PRAM 1230 as one type of non-volatile memory.

The memory unit 1200 may include a region storing user data, and a region storing metadata M_DATA. The user data may include data such as files used by a user, and the metadata M_DATA may include other various dataa. The metadata M_DATA may include a variety of software for a memory operation, for example, a flash translation layer (FTL) for an operation of the flash memory 1220, or information associated with files stored in the memory unit 1200.

Such a storage example is shown in FIG. 1A, where the PRAM 1210 may store the metadata M_DATA in the memory unit 1200, and the flash memory 1220 may store the user data. Alternatively, the PRAM 1210 may store the user data in addition to the metadata M_DATA or the flash memory 1220 may further store at least a part of the metadata M_DATA in addition to the user data.

The names of the components of the memory system 100 are only an example applicable to the inventive concepts. The memory controller unit 1100 and the memory unit 1200 may be implemented with different semiconductor chips (or different semiconductor devices). The memory controller unit 1100 may be named a memory controller and the memory unit 1200 may be named a memory device. The memory system 100 may be defined as including only the memory controller and the memory device, and a memory system including a memory controller and a memory device may be implemented using a memory card such as a secure digital (SD) memory card or an multi-media card (MMC).

The non-volatile memory device 1000 and the host 2000 may be connected to each other by a standardized interface such as ATA, SATA, USB, SCSI, ESDI, PCE-express, or IDE interface, or may also be connected to each other by other interfaces. The host 2000 may be any device that uses the non-volatile memory device 1000, such as a personal digital assistance (PDA), a computer, a digital audio player, a digital camera, a mobile terminal, or the like.

The memory system 100 may use various types of memories, and special management of memories is needed for some reasons such as the fact that the memories have different data units on which read and write operations or an erasure operation is performed or the fact that overwriting is not performed on some memories. Accordingly, as shown in FIG. 1A, the memory controller unit 1100 may include at least one software module as a translation layer for driving the memory unit 1200. For example, the memory controller unit 1100 may include a host interface module 1110 that interfaces with the host 2000, a format conversion module 1120 that controls generation of the metadata M_DATA which will be stored in the memory unit 1200 and controls conversion of the format of the metadata M_DATA, an address conversion module 1130 that maps an address from the host 2000 with an address of the memory unit 1200, and a memory interface module 1140 that generates various control signals for controlling an operation of the memory unit 1200.

The format conversion module 1120 controls generation and format conversion of the metadata M_DATA which is to be stored in the memory unit 1200. File information, which is an example of the metadata M_DATA, may include a variety of pieces of information such as a name, a storage location, a size, and a creation time of a file. The file information may be created when the file is initially stored in the memory unit 1200 and stored with the file in the memory unit 1200. To store the metadata M_DATA, a command CMD, an address ADD, and the metadata M_DATA are provided from the memory controller unit 1100 to the memory unit 1200. As described above, it is assumed that the file being user data is stored in the flash memory 1220 and that the metadata M_DATA corresponding to the file is stored in the PRAM 1210.

When a file stored in the memory unit 1200 is accessed, metadata M_DATA corresponding to the file may be updated. For example, when a write operation is performed on a file stored in the memory unit 1200, information such as a write time and a size of the file, may be updated in the metadata M_DATA. The updated metadata M_DATA information is re-written to a fixed region (for example, a region where information such as a write time and a size of a file is stored) of the PRAM 1210.

The PRAM 1210 has a limited operational lifespan. For example, the lifespan of the PRAM 1210 may be limited to about 10̂8 to 10̂9 read/write operations. The wear-out of a specific region of the PRAM 1210 may render the entire memory unit 1200 inoperable. Therefore, when a file is frequently accessed and its corresponding metadata M_DATA is located in a fixed region, the lifespan of the memory unit 1200 may be reduced due to wear-out of a specific region of the PRAM 1210, which stores the metadata M_DATA.

In one or more example embodiments of the inventive concepts, the wear-out of a specific region of the PRAM 1210 may be addressed using format conversion of the metadata M_DATA, which will be described in detail below.

FIG. 1B illustrates an example where the PRAM 1230 included in the memory unit 1200 stores both user data and metadata M_DATA. A file is stored in some region of the PRAM 1230, metadata M_DATA corresponding to the file is stored in another region of the PRAM 1230, where at least some of the metadata M_DATA is updated when the file is accessed.

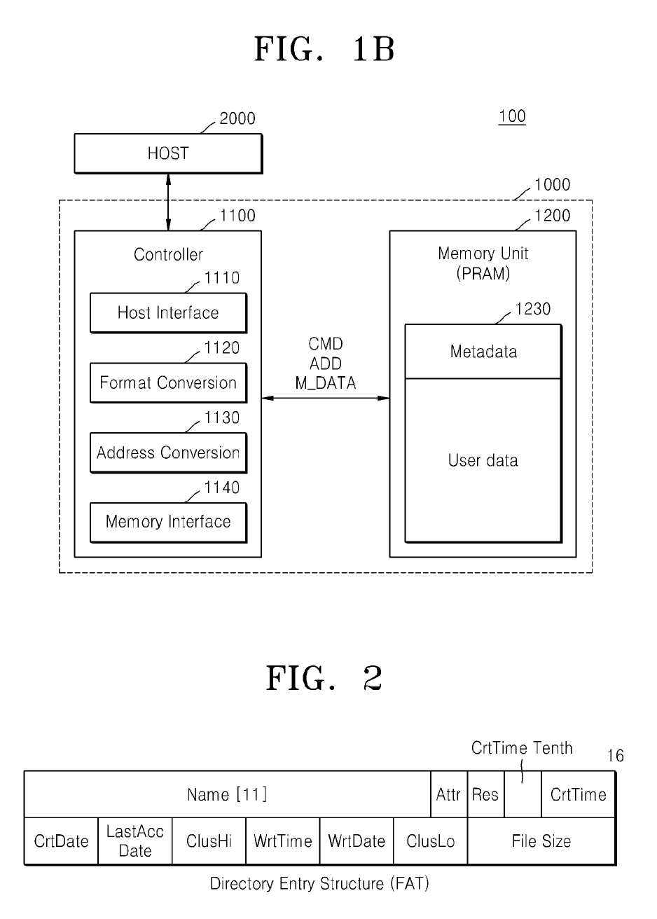

FIG. 2 illustrates an example of a format of metadata used in one or more example embodiments of the inventive concepts.

FIG. 2 illustrates the structure of a directory entry of a file allocation table (FAT) file system that stores file information, as an example of metadata. Although a FAT file system is illustrated in FIG. 2, the inventive concepts are not limited thereto. The inventive concepts may be applied to other file systems such as a Journaling Flash File System (JFFS), a YA Flash File System (YAFFS), and a Tiny File System (TFS).

The FAT file system provides, as metadata, a directory entry having a structure as shown in FIG. 2. For example, a directory entry having information associated with a single file may have a size of 32 bytes, and, when a minimum data unit in which user data is written is defined as a cluster, a location of a cluster in which the file is written may be detected by referring the directory entry.

The directory entry may include a plurality of segments that store information associated with a file, and each of the segments may be set to have a predetermined size and store information corresponding to the size. For example, the directory entry may include Name of 11 bytes containing file name and extension information, creation time information CrtTime of 2 bytes, last access date information LastAcc Date of 2 bytes, cluster location information ClusHi and ClusLo of 4 bytes, write time information WrtTime of 2 bytes, and file size information File Size of 4 bytes. The directory entry may include signature information Res having a predetermined value, and the signature information Res may have a size of predetermined bytes (for example, one byte). The directory entry may include other pieces of information such as a property of a file, and for the sake of brevity a detailed description thereof will be omitted.

The various information segments associated with a file described above undergo consistent updating, resulting in wear and tear on the memory unit. These various pieces of information associated with a directory entry of a file may have different update frequencies. For example, every time a file is accessed, the write time information WrtTime and the file size information File Size in the directory entry may have higher update frequencies than the other pieces of information. The write time information WrtTime or the file size information File Size is updated every time writing is performed on a file.

In PRAMs, a write operation is performed in units of a word having a defined size. For example, the word may have a size of 4 bytes. According to the format of the directory entry of FIG. 2, a fixed region (a region where the write time information WrtTime and the file size information File Size are stored) of a PRAM is updated every time a file is written. Thus, lifespan reduction may occur due to the wear-out of a part of the PRAM 1200.

According to an example embodiment of the inventive concepts, the memory controller unit 1100 of FIGS. 1A and 1B efficiently performs wear leveling without an unnecessary data copy operation by varying the format of the metadata M_DATA that is provided to the memory unit 1200 so that wear leveling of the metadata M_DATA is performed.

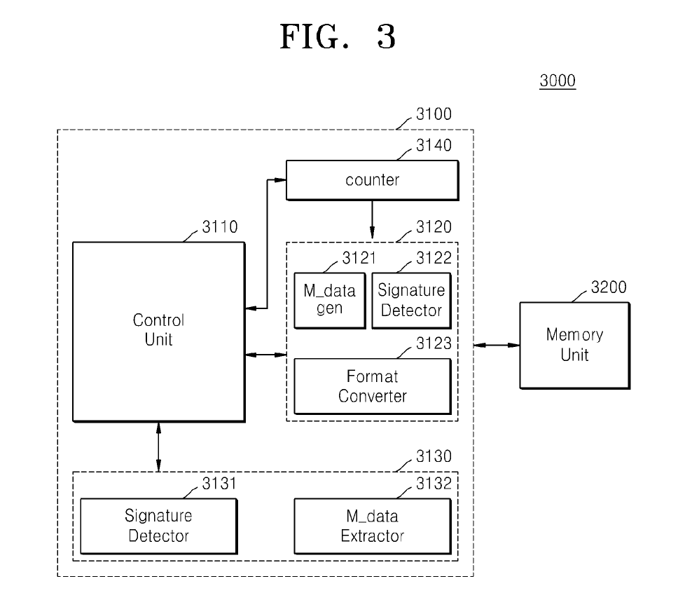

FIG. 3 is a block diagram of an embodiment of the non-volatile memory device 1000 of FIGS. 1A and 1B.

As shown in FIG. 3, a non-volatile memory device 3000 according to an example embodiment of the inventive concepts may include a memory controller unit 3100 and a memory unit 3200. As described above, the memory unit 3200 may include one type of non-volatile memory or at least two types of non-volatile memories. For example, when the memory unit 3200 includes only a PRAM, files and metadata may be stored in the PRAM. Alternatively, when the memory unit 3200 includes a PRAM and a flash memory, the metadata may be stored in the PRAM and the files may be stored in the flash memory.

The memory controller unit 3100 may include a control unit 3110, a metadata provision unit 3120, a metadata detection unit 3130, and a counter 3140. The metadata provision unit 3120 may include a metadata generator 3121, a signature generator 3122, and a format converter 3123. The metadata detection unit 3130 may include a signature detector 3131 and a metadata extractor 3132. The memory controller unit 3100 may further include a unit that generates various command signals for controlling the memory unit 3200, a unit that generates or converts an address provided to the memory unit 3200, or other units not necessarily shown in FIG. 3.

A detailed operation of the non-volatile memory device 3000 that may be constructed as described above will be described below. An operation associated with format conversion of metadata stored in the memory unit 3200 will now be mainly described. It is assumed that the metadata has information associated with a file.

The control unit 3110 controls the overall operations performed in the memory controller unit 3100. For example, the control unit 3110 controls the counter 3140 which performs a counting operation when a file stored in the memory unit 3200 is accessed, controls metadata generation and conversion operations of the metadata provision unit 3120, and controls a metadata detection operation of the metadata detection unit 3130. The metadata provision unit 3120 generates metadata corresponding to a file when the file is stored in the memory unit 3200, and converts the format of the metadata which is to be written to the memory unit 3200 according to an access status of the file. The metadata detection unit 3130 detects various pieces of information associated with the file by using metadata read from the memory unit 3200.

When a file is initially stored in the memory unit 3200 or the file is accessed, the metadata generator 3121 generates various pieces of information corresponding to the file. As described above, when metadata is a directory entry of a FAT file system, the metadata may include information relating to: creation time information, last access date information, storage location information, write time information, file size information, and the like of files. The signature generator 3122 generates signature information which is to be included in the metadata, and the format converter 3123 converts the format of the metadata by re-constructing the generated metadata and the generated signature information. When a file stored in the memory unit 3200 is accessed, at least some of the information pieces, stored in metadata may be updated, and the metadata generator 3121 generates updates about the at least some information pieces stored in the metadata, namely segments of information. Although the metadata generator 3121 and the signature generator 3122 are separate units in FIG. 3, file information and signature information may be both generated by a single generation unit.

The format converter 3123 converts the format of the metadata by re-constructing metadata and signature information based on a result of the counting of the number of times the file is accessed, leveling wear on the memory unit 3200. For example, the format converter 3123 converts the format of the metadata when the number of times the file is accessed exceeds a threshold value. The format conversion of the metadata may be performed by varying a region of the memory unit 3200 that stores various pieces of information constituting the metadata. The format converter 3123 reconstructs the metadata and the signature information based on the result of the counting performed by the counter 3140 and provides a result of the reconstruction as the format-converted metadata to the memory unit 3200.

The metadata detection unit 3130 detects information associated with a file by using metadata read from the memory unit 3200. When an access to a file stored in the memory unit 3200 is requested by an external source, metadata corresponding to the file is provided to the metadata detection unit 3130, and the signature detector 3131 detects signature information from the information pieces of the metadata. The metadata extractor 3132 may extract the various information pieces of the metadata based on the detected signature information. For example, the signature detector 3131 may detect signature information by comparing information of metadata with a preset value, and the metadata extractor 3132 extracts pieces of information existing in a location in relation to the signature information. When the metadata is a directory entry of a FAT file system as shown in FIG. 2, information stored in the metadata may also be extracted by detecting signature information existing in a location.

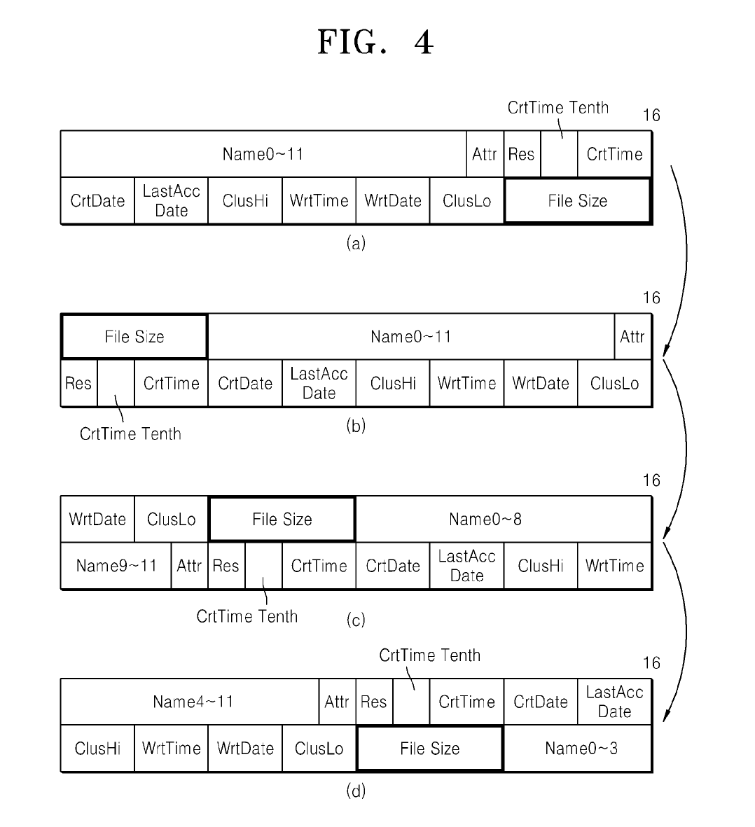

A detailed operation of the non-volatile memory device 3000 of FIG. 3 will now be described with reference to FIGS. 3 and 4.

FIG. 4 illustrates an example of converting a format of a directory entry of a FAT file system as an example of metadata. In FIG. 4, metadata is stored in a PRAM, and it is assumed that a word, which is a data unit on which a write operation is performed on the PRAM, has a size of 4 bytes. Metadata may be embodied in various sizes. In the example embodiment discussed, it is assumed that the Metadata has a size of 32 bytes (8 words). It is further assumed that a row of the PRAM is 16 bytes, thus, the Metadata illustrated in FIG. 4 is stored in two rows of the PRAM.

Metadata having the format of FIG. 4 (a) may be created when a file is initially created, and stored in the PRAM of the memory unit 3200.

When the file is accessed, the metadata stored in the PRAM is updated. For example, when a write operation is performed on the file, write time information WrtTime and file size information File Size of metadata corresponding to the file are updated. Alternatively, when another access (for example, a read operation) to the file is performed, another piece of information (for example, last access date information LastAcc Date) of the metadata is updated. To update metadata information, the memory controller unit 3100 provides update information and an address of the corresponding metadata to the memory unit 3200.

In one or more example embodiments, when a file is accessed, a corresponding count of the number of times a region of the PRAM that stores the associated metadata is increased. Based on the count, the format of the metadata is converted and stored in the PRAM.

For example, when the file is accessed a certain number of times, the format of the metadata is converted from the layout illustrated in FIG. 4A to the layout shown in FIG. 4(b), and thus locations on the PRAM that store the segments of the metadata are changed. For example, FIG. 4 (b) illustrates an example where locations on the PRAM that store the segments of the metadata are shifted by 4 bytes. When the Metadata is moved 4 bytes in a certain direction (in the drawings, a direction where an address increases) the location of the file size information FileSize is changed along with other information stored in the Metadata.

As the file continues to be accessed the metadata information is continuously updated. For example, the write time information WrtTime and the file size information File Size may be updated every write operation performed on the file. However, in one or more example embodiments because the segments shift, the update operation is performed in a different region of the PRAM. Accordingly, the possibility of a wear-out of the PRAM due to a concentration of updates to a specific region of the PRAM is reduced, thereby increasing the lifespan of the PRAM.

After the format conversion of the metadata, as shown in FIG. 4(b), a count representing the number of access requests is reset and the number of a requests for an access to the file continues. When the re-counted number of accesses exceeds a threshold value, the format of the metadata is converted again. For example, a location of the file size information FileSize of 4 bytes on the PRAM is further moved by 4 bytes, and thus the format of the metadata is converted into the format shown in FIG. 4 (c). The format-converted metadata is re-stored in the PRAM and a new counting operation is performed by resetting the counting value. A counting operation and a comparison operation with respect to the threshold value are performed every time the file is accessed, and format conversion of the metadata as described above is performed according to a result of the comparison to generate metadata having a format of FIG. 4(d). In the example of FIG. 4, since the metadata of the file has a size of 32 bytes and the format conversion of the metadata is performed by movement of information of a 4-byte size, the metadata may have 8 different formats.

According to an example embodiment as described above, regions where information update occurs may be evenly distributed on the PRAM storing the metadata. In other words, information that is frequently updated during an access to a file is periodically moved within a region storing the metadata (for example, a 32-byte region of the PRAM), thereby preventing frequent update of a specific region of the PRAM. According to an example embodiment, as described above, the wear-out may be prevented by performing wear leveling through update in units of words certain byte size instead of performing wear leveling in units of memory blocks. Accordingly, contrary to wear leveling based on memory blocks, operations such as copying of data stored in the memory block do not need to be performed, and thus efficient wear leveling is possible.

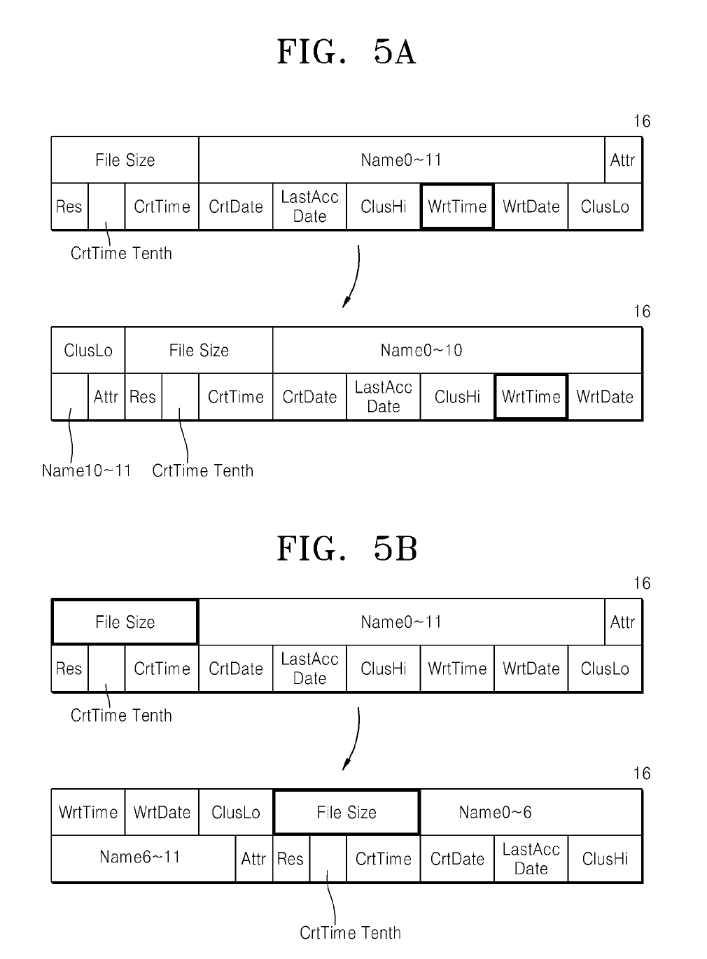

FIGS. 5A and 5B illustrate another example of converting a format of metadata.

FIG. 5A illustrates an example of converting a format of metadata based on different metadata information from the File Size information used in FIG. 4, for example, write time information WrtTime of a file. The write time information WrtTime may have a size of 2 bytes.

Metadata having a first format is stored in the PRAM, and pieces of the metadata are updated every time a file corresponding to the metadata is accessed. The number of times the file is accessed may be counted, and a result of the counting is compared with a threshold value. When the result of the counting exceeds the threshold value, the metadata may be converted from a first format into a second format.

The metadata having the second format is provided to and stored in the PRAM. The second format may be obtained by shifting the metadata information of the first format in a certain direction (in the drawings, a direction where an address increases). Accordingly, locations of the write time information WrtTime and other information pieces on the PRAM are moved 2 bytes. After performing the conversation, the counting value is reset in the same way discussed with regard FIG. 4. Although not shown in FIG. 5A, further update operations due to an access to the file increase the value of the reset counter. When the number of times the file is accessed again exceeds the threshold value, the second format of the metadata is converted again.

Referring to FIG. 5A, since the metadata is only shifted by 2 bytes and the file size information is 4 bytes, the file size information FileSize in the first format may be overlapped with the file size information FileSize in the second format, and an overlapping region between them may be frequently updated. However, while updating may occur more frequently in comparison to FIG. 4, regions where the metadata is updated are still evenly distributed on the PRAM, since segments of information stored in the metadata move cyclically within a 32-byte size region of the PRAM as the number of times a file corresponding to the metadata is accessed.

FIG. 5B illustrates another example of converting a format of metadata. FIG. 5B illustrates an example where format conversion of the metadata is performed without regard to the size of a piece of information constituting the metadata. According to this example, regions where frequent updating occurs due to an access to a file may be evenly distributed on the PRAM by performing format conversion wherein the amount of movement of each piece of information constituting the metadata is not tied to the size of a specific piece of information stored in the metadata.

Referring to FIG. 5B, format conversion is performed by moving each piece of information constituting the metadata by 6 bytes.

Although not shown in FIGS. 4, 5A and 5B, without needing to count the number of times a file is accessed in the same format of the metadata, regions where frequent updating occurs due to an access to the file may be evenly distributed on the PRAM by moving the metadata a certain (or, alternatively a predetermined) amount at regular intervals every time the file is accessed. When the format of metadata is converted by such information movement, the total number of formats of the metadata that can be defined may be limited. For example, although the format of metadata is converted into one of the 8 formats in FIG. 4, only some of the 8 formats may be defined and the metadata may be converted into one of the defined formats.

Moreover, although FIGS. 4, 5A, and 5B illustrate a directory entry of a FAT file system as an example of metadata and illustrate metadata format conversion performed according to a result of counting the number of accesses to a file, embodiments are not limited thereto, and format conversion may also be performed on metadata such as software for operating a memory device. For example, metadata not associated with user data may be used during operation of a memory device, and the format of the metadata may be converted based on a result of counting the number of times the metadata is referred to (or accessed).

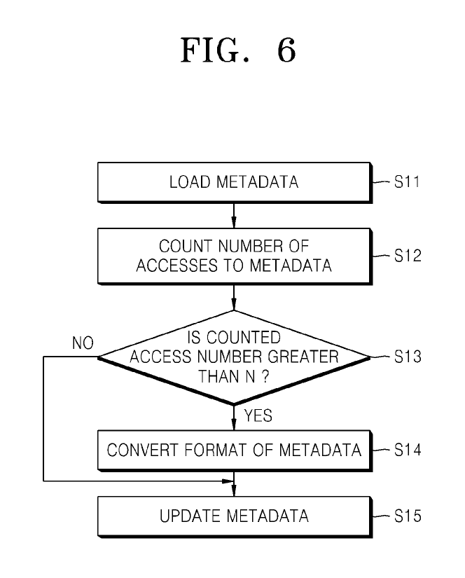

FIG. 6 is a flowchart of a method of operating a non-volatile memory device, according to one or more example embodiments.

In FIG. 6, it is assumed that metadata includes a variety of software for an operation of the non-volatile memory device. It is also assumed that the metadata is stored in a PRAM of the non-volatile memory device.

As shown in FIG. 6, as a system including the non-volatile memory device is driven, the metadata is loaded into the PRAM of the non-volatile memory device in operation S11. The loading occurs when the metadata may be stored in another memory (for example, non-volatile memory such as flash memory) of the non-volatile memory device or in memory (for example, a hard disk drive) outside the non-volatile memory device and therefore is loaded into the PRAM when the system is driven in operation S11. Alternatively, when the metadata is pre-stored in the PRAM of the non-volatile memory device, operation S11 may be omitted. The loaded metadata may include a plurality of types of information having a certain format.

Thereafter, as the system including the non-volatile memory device operates, the metadata stored in the PRAM may be accessed, and a memory operation is performed on accessed information. As the memory operation is performed, pieces of information related with the status, property, and the like of the non-volatile memory device may be changed, and thus at least some of the metadata information may be updated. In operation S12, as the metadata is accessed, a counter that counts the number of accesses is increased. In operation S13, the counted access number is compared with a threshold value to determine whether the counted access number is greater than the threshold value. In operation S14, when the counted access number is greater than the threshold value, the format of the metadata is converted and a result of the conversion is stored in the PRAM.

The format of the metadata may be converted using one of the above-described embodiments. When the metadata includes a plurality of pieces of information and is stored in a region of the PRAM having a certain (or alternatively a predetermined) size, if it is determined that the counted access number is greater than the threshold value, the format of the metadata may be converted by moving the locations of the metadata information by a desired (or, alternatively a predetermined) amount within the region of the PRAM. A plurality of formats is defined according to the locations of the metadata information, and the metadata is converted into one of the defined formats. The movement of the metadata information may be performed in a certain direction by a size of one of the information segments associated with the metadata or at regular intervals of a desired (or alternatively a predetermined) amount regardless of the size of the space allocated to the information segments. The format conversion is not limited thereto and may be performed according to various other methods. The format conversion may be performed in such a way that the metadata information cyclically moves within the region of the PRAM having a desired (or, alternatively a predetermined) size.

In operation S15, when the counted access number is less than the threshold value, the metadata is updated according to a current format, and, when the counted access number is greater than the threshold value, metadata having the converted format is updated. A memory controller unit of a semiconductor memory device provides metadata having a converted format to a PRAM, so that some of the metadata information is prevented from being frequently updated at the same locations on the PRAM.

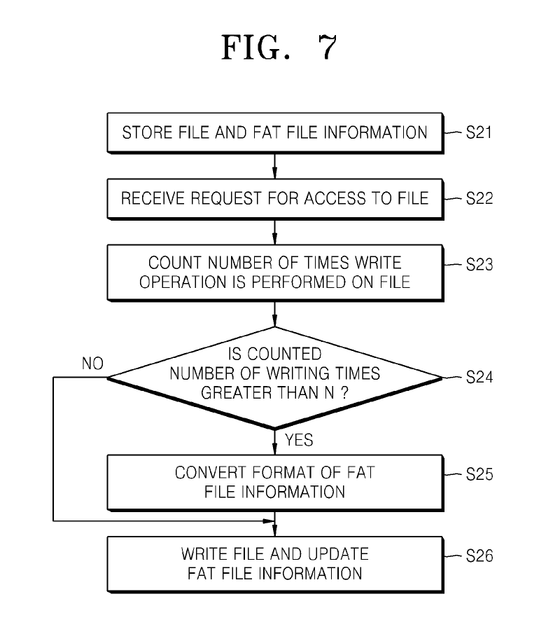

FIG. 7 is a flowchart of a method of operating a non-volatile memory device, according to another example embodiment.

FIG. 7 illustrates an example in which a system operating based on a FAT file system stores, as metadata, FAT file information associated with a file that is stored as user data in a memory. It is assumed that the FAT file information is stored in a PRAM of a semiconductor memory device.

As shown in FIG. 7, as a file is created and stored in the semiconductor memory device, the FAT file information corresponding to the file is created in a memory controller unit and stored in the PRAM in operation S21. The FAT file information may include various pieces of information such as a name, a storage location, a size, and a creation time of the file. As the file is accessed, at least some of the information pieces may be changed and updated.

In operation S22, a request for an access to the file is received from an external host for various purposes, for example, a request to write data to the file may be received. When a write request is received, the number of times a write operation is performed on the file is counted in operation S23, and the counted number of writing times is compared with a threshold value in operation S24. In operation S25, when the counted number of writing times is greater than the threshold value, the format of the FAT file information to be stored in the PRAM is converted.

In FIG. 7, a counting operation is performed only on some of the accesses to the file. For example, some (write time information and file size information) of the various information pieces included in the FAT file information are updated every time a write operation on the file is performed, and, as the write operation on the file is frequently performed compared to the other operations, the FAT file information is accordingly frequently updated. Accordingly, a counting operation for format conversion of the FAT file information may be performed when a write operation from among access operations on the file is requested, and thus the number of write operations performed on the file may be counted and compared with a threshold value. Even when a specific type of access requiring update of the FAT file information other than the write operation is performed, a counting operation may be additionally performed.

In operation S26, when the counted number of writing times is less than the threshold value, the FAT file information is updated according to a current format, and, when the counted number of writing times is greater than the threshold value, FAT file information having a converted format is updated. The memory controller unit of the semiconductor memory device provides the PRAM with a FAT file information having the converted format thus preventing some of the FAT file information from being frequently updated at the same locations on the PRAM.

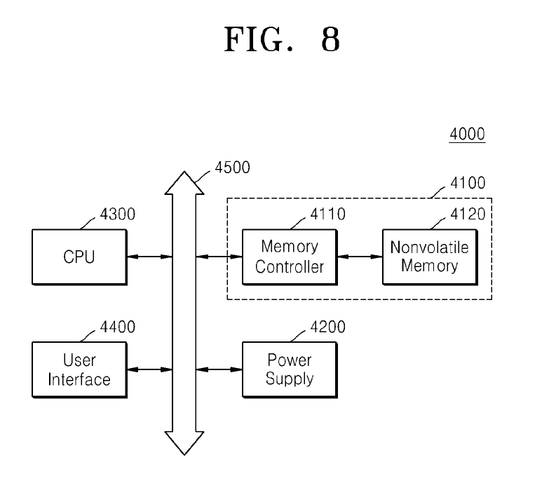

FIG. 8 is a block diagram of a memory system 4000 including a non-volatile memory device 4100, according to an example embodiment.

Referring to FIG. 8, the memory system 4000 may include the non-volatile memory device 4100, a power supply device 4200, a central processing unit (CPU) 4300, and a user interface 4400 which are connected to each other via a system bus 4500. The non-volatile memory device 4100 may include a memory controller 4110, which controls a memory operation, and a memory unit 4120, which performs a memory operation such as writing, reading, or the like, under the control of the memory controller 4110. The memory unit 4120 includes a region where user data is stored and a region where metadata including information associated with the user data is stored. For example, the metadata may be stored in a PRAM and the user data may be stored in the PRAM or another non-volatile memory.

The CPU 4300 provides a request signal for a memory operation to the non-volatile memory device 4100, and the non-volatile memory device 4100 performs an operation of accessing the memory unit 4120 in response to the request signal. The request signal includes an access request for accessing a file stored in the memory unit 4120. The memory controller 4110 generates a control signal for an access operation such as a write operation, a read operation, or the like on the file in response to the access request. At least one of various pieces of information included in metadata corresponding to a file is updated when the file is accessed. The memory controller 4110 converts the format of metadata which is to be stored in the memory unit 4120, based on a result of counting the number of times the file is accessed. Format-converted metadata is stored in a corresponding region of the memory unit 4120.

Although not shown in FIG. 8, it is apparent to one of ordinary skill in the art that the memory system 4000 may further include an application chipset, a camera image processor (CIS), a mobile DRAM, and the like.

In a non-volatile memory device and a method of operating the same according to one or more example embodiments as described above, wear leveling is performed based on format conversion of metadata, and thus unnecessary data copying operations are reduced, whereby efficient wear leveling is possible and update endurance may be increased.

While the inventive concept has been particularly shown and described with reference to exemplary embodiments thereof, it will be understood that various changes in form and details may be made therein without departing from the spirit and scope of the following claims.

What is claimed is:

1. A non-volatile memory device comprising:
a memory unit configured to store user data and metadata; and
a memory controller unit configured to,
access the memory unit in response to a request from an external host,
create metadata to be recorded in the memory unit, and
convert a format of the metadata based on a result of counting a number of times the memory unit is accessed.

2. The non-volatile memory device of claim 1, wherein the memory controller unit comprises:
a metadata provision unit configured to,
generate and convert the metadata, and
provide the metadata to the memory unit;
a metadata detection unit configured to,
receive the metadata from the memory unit, and
extract at least one piece of information included in the metadata; and
a counter configured to count the number of times the memory unit is accessed.

3. The non-volatile memory device of claim 2, wherein
the metadata comprises a plurality of segments that store a plurality of pieces of information, and
the metadata provision unit is configured to convert the format of the metadata by varying storage locations of the plurality of segments on the memory unit.

4. The non-volatile memory device of claim 1, wherein
the metadata comprises file information associated with the user data, and
the memory controller unit is configured to convert a format of the file information based on a result of counting the number of times the user data stored in the memory unit is accessed.

5. The non-volatile memory device of claim 4, wherein the file information is a directory entry of a file allocation table (FAT) file system.

6. The non-volatile memory device of claim 4, wherein the memory controller unit is configured to:
count a number of times a write operation is performed on the user data stored in the memory unit, and
convert the format of the file information based on a result of the counting.

7. The non-volatile memory device of claim 1, wherein the memory unit comprises a first memory configured to store the user data and a second memory configured to store the metadata.

8. The non-volatile memory device of claim 7, wherein the second memory is a Phase-change Random Access Memory (PRAM).

9. A method of operating a non-volatile memory device, the method comprising:
storing user data and metadata in a memory, the metadata including a plurality of pieces of information;
performing an access operation on the memory to read at least one of the user data and the metadata;
converting a format of the metadata by varying storage locations of the plurality of pieces of information; and
updating the format-converted metadata in the memory.

10. The method of claim 9, further comprising:
counting a number of times the memory is accessed to generate a count; and
comparing the count with a threshold value,
wherein the format of the metadata is converted according to a result of the comparison.

11. The method of claim 10, wherein
the metadata is file information associated with the user data, and
the converting converts a format of the file information based on a result of counting the number of times the user data stored in the memory is accessed.

12. The method of claim 11, wherein the file information is a directory entry of a file allocation table (FAT) file system.

13. The method of claim 9, wherein the storing stores metadata in a Phase-change Random Access Memory (PRAM) of the memory.

14. The method of claim 9, wherein
the storing stores metadata in a first region of the memory, and
the converting circulates the pieces of information of the metadata among the storage locations within the first region according to the format conversion of the metadata.

15. The method of claim 9, wherein a plurality of formats are defined for the metadata, and the converting converts the metadata into one of the plurality of formats and the updating updates the memory.

16. A semiconductor device, comprising:
a memory unit configured to store user data and metadata; and
a memory controller configured to,
generate the metadata,
generate a memory count value representing a number of times a memory unit is accessed,
convert the metadata based on the generated memory count value, and
record the user data and metadata in the memory unit.

17. The semiconductor device of claim 16, wherein
the metadata comprises a plurality of information segments; and
the memory controller is configured to convert the metadata by shifting the information segments to different locations within the memory unit.

18. The semiconductor device of claim 16, wherein
the metadata comprises file information associated with the user data,
the memory controller is further configured to,
generate a user data count value representing a number of times the user data is accessed, and
convert the file information based on the generated user data count value.

19. The semiconductor device of claim 18, wherein the memory controller is configured to convert the file information by shifting where the file information is stored within the memory unit.

20. The semiconductor device of claim 19, wherein the file information is a directory entry of a file allocation table (FAT) file system.
